(19) United States
(12) Patent Application Publication
(10) Pub. No.: US 2016/0171931 A1
(43) Pub. Date: Jun. 16, 2016

(54) Reduced Image Sticking OLED Display

(71) Applicant: Universal Display Corporation, Ewing, NJ (US)

(72) Inventors: Chun Hsin Liu, Ewing, NJ (US); Michael Hack, Princeton, NJ (US); Michael Stuart Weaver, Princeton, NJ (US); Vadim Adamovich, Yardley, PA (US)

(21) Appl. No.: 14/571,237

(22) Filed: Dec. 15, 2014

(51) Int. Cl. G09G 3/32; G09G 3/20

(52) U.S. Cl. CPC G09G 3/3233; G09G 3/2003; G09G 2320/0223; G09G 2320/0295; G09G 2320/043; G09G 2320/041

(57) ABSTRACT

Methods of operation and devices are provided in which the operation of a full-color display is modified based upon historical luminance data that indicates an intensity at which at least one sub-pixel of the device is driven over a period of time. An expected degradation level of one or more pixel elements in the device is calculated based upon the luminance data, and video signals received by the device are modified based upon the expected degradation level to reduce image sticking and/or other undesirable effects in the device.

### PARTIES TO A JOINT RESEARCH AGREEMENT

The claimed invention was made by, on behalf of, and/or in connection with one or more of the following parties to a joint university corporation research agreement: Regents of the University of Michigan, Princeton University, University of Southern California, and the Universal Display Corporation. The agreement was in effect on and before the date the claimed invention was made, and the claimed invention was made as a result of activities undertaken within the scope of the agreement.

### FIELD OF THE INVENTION

The present invention relates to devices with variable operation based upon historical luminance data, including devices such as organic light emitting diodes and other devices, including the same.

### BACKGROUND

Opto-electronic devices that make use of organic materials are becoming increasingly desirable for a number of reasons. Many of the materials used to make such devices are relatively inexpensive, so organic opto-electronic devices have the potential for cost advantages over inorganic devices. In addition, the inherent properties of organic materials, such as their flexibility, may make them well suited for particular applications such as fabrication on a flexible substrate. Examples of organic opto-electronic devices include organic light emitting devices (OLEDs), organic phototransistors, organic photovoltaic cells, and organic photodetectors. For OLEDs, the organic materials may have performance advantages over conventional materials. For example, the wavelength at which an organic emissive layer emits light may generally be readily tuned with appropriate dopants.

OLEDs make use of thin organic films that emit light when voltage is applied across the device. OLEDs are becoming an increasingly interesting technology for use in applications such as flat panel displays, illumination, and backlighting. Several OLED materials and configurations are described in U.S. Pat. Nos. 5,844,363, 6,303,238, and 5,707,745, which are incorporated herein by reference in their entirety.

One application for phosphorescent emissive molecules is a full color display. Industry standards for such a display call for pixels adapted to emit particular colors, referred to as “saturated” colors. In particular, these standards call for saturated red, green, and blue pixels. Color may be measured using CIE coordinates, which are well known to the art.

One example of a green emissive molecule is tris(2-phenylpyridine) iridium, denoted Ir(ppy)₃, which has the following structure:

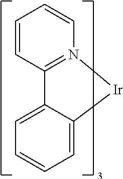

In this, and later figures herein, we depict the dative bond from nitrogen to metal (here, Ir) as a straight line.

As used herein, the term “organic” includes polymeric materials as well as small molecule organic materials that may be used to fabricate organic opto-electronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be a fluorescent or phosphorescent small molecule emitter. A dendrimer may be a “small molecule,” and it is believed that all dendrimers currently used in the field of OLEDs are small molecules.

As used herein, “top” means furthest away from the substrate, while “bottom” means closest to the substrate. Where a first layer is described as “disposed over” a second layer, the first layer is disposed further away from substrate. There may be other layers between the first and second layer, unless it is specified that the first layer is “in contact with” the second layer. For example, a cathode may be described as “disposed over” an anode, even though there are various organic layers in between.

As used herein, “solution processible” means capable of being dissolved, dispersed, or transported in and/or deposited from a liquid medium, either in solution or suspension form.

A ligand may be referred to as “photoactive” when it is believed that the ligand directly contributes to the photoactive properties of an emissive material. A ligand may be referred to as “ancillary” when it is believed that the ligand does not contribute to the photoactive properties of an emissive material, although an ancillary ligand may alter the properties of a photoactive ligand.

As used herein, and as would be generally understood by one skilled in the art, a first “Highest Occupied Molecular Orbital” (HOMO) or “Lowest Unoccupied Molecular Orbital” (LUMO) energy level is “greater than” or “higher than” a second HOMO or LUMO energy level if the first energy level is closer to the vacuum energy level. Since ionization potentials (IP) are measured as a negative energy relative to a vacuum level, a higher HOMO energy level corresponds to an IP having a smaller absolute value (an IP that is less negative). Similarly, a higher LUMO energy level corresponds to an electron affinity (EA) having a smaller absolute value (an EA that is less negative). On a conventional energy level diagram, with the vacuum level at the top, the LUMO energy level of a material is higher than the HOMO energy level of the same material. A “higher” HOMO or LUMO energy level appears closer to the top of such a diagram than a “lower” HOMO or LUMO energy level.

As used herein, and as would be generally understood by one skilled in the art, a first work function is “greater than” or “higher than” a second work function if the first work function has a higher absolute value. Because work functions are generally measured as negative numbers relative to vacuum level, this means that a “higher” work function is more negative. On a conventional energy level diagram, with the vacuum level at the top, a “higher” work function is illustrated as further away from the vacuum level in the downward direction. Thus, the definitions of HOMO and LUMO energy levels follow a different convention than work functions.

More details on OLEDs, and the definitions described above, can be found in U.S. Pat. No. 7,279,704, which is incorporated herein by reference in its entirety.

### SUMMARY OF THE INVENTION

In an embodiment, historic operational data for at least a portion of a display device that includes a display may be obtained. An expected degradation level of a sub-pixel within an active area of the display may be calculated based upon the historic operational data, and a video signal received by the display device may then be modified based upon the expected degradation level to generate a modified video signal. The

modified video signal can be provided to the display. The historic operational data may include a cumulative brightness at which the display is driven over the period of time. The modification may be made in real time, for example, as the video signal is received and processed by the display. The historic operational data may be obtained, and/or the expected degradation level may be calculated, prior to the modified video signal being provided to the display. The expected degradation level may be calculated, for example, according to:

$${R}_{M} = {R}_{0} * {[ \frac{{L}_{M}}{{L}_{0}} ]}^{n} * [ \frac{{τ}_{M}}{{τ}_{0}} ] * exp [ \frac{Δ E}{k} * ( \frac{1}{{T}_{M}} - \frac{1}{{T}_{0}} ) ]$$

The historic operational data may include, for example, a sum of an average luminance of one or more sub-pixels over a period of time. It may be stored in a computer-readable memory of the display device, and may be updated occasionally or periodically during operation of the display. The expected degradation level also may be calculated based upon other data, such as temperature data received from a sensor in the display. The video signal may be modified by, for example, adjusting a current provided to a sub-pixel in the display. The adjustment may be made based upon the expected degradation level, and/or upon an expected luminance of a sub-pixel that is expected to be the most-degraded sub-pixel or sub-pixel type in the display. The expected degradation of a sub-pixel in the display also may be calculated based upon a characteristic of a dummy sub-pixel disposed outside an active area of the display, such as the historic luminance, and/or calculated or measured degradation of the dummy sub-pixel.

According to an embodiment, a display device may include a full-color display; a computer-readable storage storing historic operational data for at least a portion of the display; and a processor configured to calculate an expected degradation level of a sub-pixel within an active area of the display based upon the historic operational data and to modify a video signal received by the display device based upon the expected degradation level. The device may be, for example, a flat panel display, a computer monitor, a medical monitor, a television, a billboard, a heads-up display, wearable display, wearable computer, electronic watch, a computer, a fully or partially transparent display, a flexible display, a laser printer, a telephone, a cell phone, a tablet, a phablet, a personal digital assistant (PDA), a laptop computer, a digital camera, a camcorder, a viewfinder, a micro-display, a 3-D display, a vehicle, a large area screen, and a sign. The expected degradation may be calculated as previously described, and may be based upon data obtained by one or more sensors within the display. The data stored by the display may be occasionally and/or periodically updated.

### BRIEF DESCRIPTION OF THE DRAWINGS

FIG. 1 shows an organic light emitting device.

FIG. 2 shows an inverted organic light emitting device that does not have a separate electron transport layer.

FIG. 3 shows an example device arrangement that includes dummy pixels arranged outside the active area of a display as disclosed herein.

FIG. 4 shows a schematic representation of an example system for performing the luminance and degradation calculations and video modification as described herein.

### DETAILED DESCRIPTION

Generally, an OLED comprises at least one organic layer disposed between and electrically connected to an anode and a cathode. When a current is applied, the anode injects holes and the cathode injects electrons into the organic layer(s). The injected holes and electrons each migrate toward the oppositely charged electrode. When an electron and hole localize on the same molecule, an “exciton,” which is a localized electron-hole pair having an excited energy state, is formed. Light is emitted when the exciton relaxes via a photoemissive mechanism. In some cases, the exciton may be localized on an excimer or an exciplex. Non-radiative mechanisms, such as thermal relaxation, may also occur, but are generally considered undesirable.

The initial OLEDs used emissive molecules that emitted light from their singlet states (“fluorescence”) as disclosed, for example, in U.S. Pat. No. 4,769,292, which is incorporated by reference in its entirety. Fluorescent emission generally occurs in a time frame of less than 10 nanoseconds.

More recently, OLEDs having emissive materials that emit light from triplet states (“phosphorescence”) have been demonstrated. Baldo et al., “Highly Efficient Phosphorescent Emission from Organic Electroluminescent Devices,” Nature, vol. 395, 151-154, 1998; (“Baldo-I”) and Baldo et al., “Very high-efficiency green organic light-emitting devices based on electrophosphorescence,” Appl. Phys. Lett., vol. 75, No. 3, 4-6 (1999) (“Baldo-II”), which are incorporated by reference in their entireties. Phosphorescence is described in more detail in U.S. Pat. No. 7,279,704 at cols. 5-6, which are incorporated by reference.

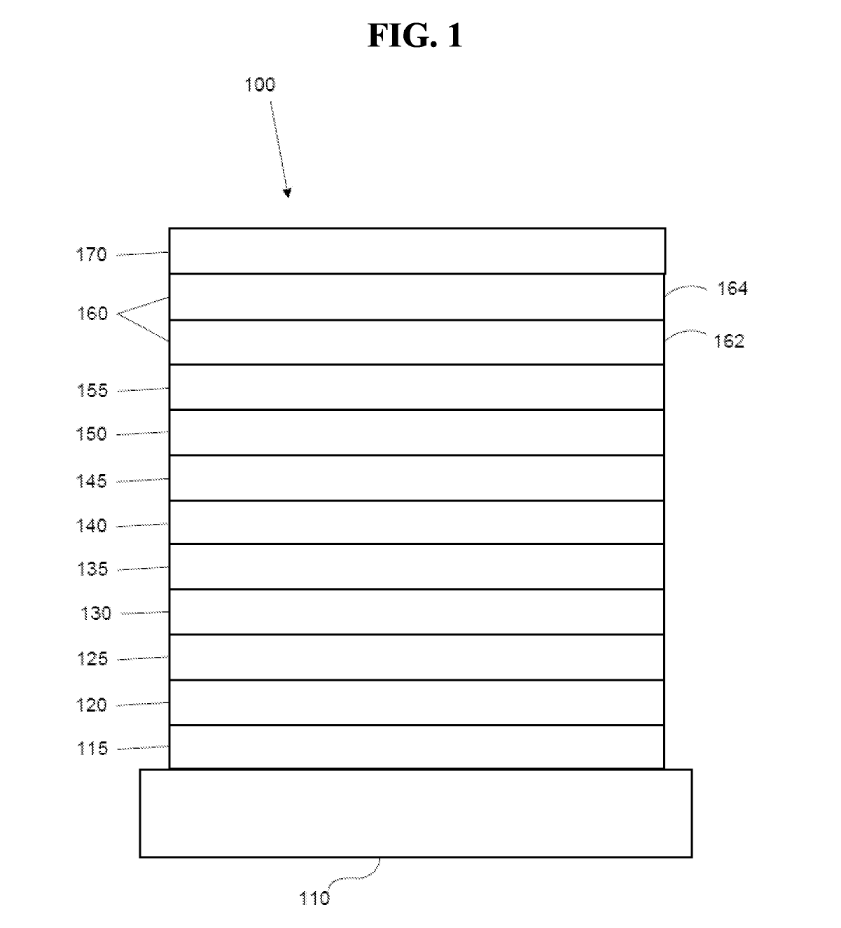

FIG. 1 shows an organic light emitting device 100. The figures are not necessarily drawn to scale. Device 100 may include a substrate 110, an anode 115, a hole injection layer 120, a hole transport layer 125, an electron blocking layer 130, an emissive layer 135, a hole blocking layer 140, an electron transport layer 145, an electron injection layer 150, a protective layer 155, a cathode 160, and a barrier layer 170. Cathode 160 is a compound cathode having a first conductive layer 162 and a second conductive layer 164. Device 100 may be fabricated by depositing the layers described, in order. The properties and functions of these various layers, as well as example materials, are described in more detail in U.S. Pat. No. 7,279,704 at cols. 6-10, which are incorporated by reference.

More examples for each of these layers are available. For example, a flexible and transparent substrate-anode combination is disclosed in U.S. Pat. No. 5,844,363, which is incorporated by reference in its entirety. An example of a p-doped hole transport layer is m-MTDATA doped with F4-TCNQ at a molar ratio of 50:1, as disclosed in U.S. Patent Application Publication No. 2003/0230980, which is incorporated by reference in its entirety. Examples of emissive and host materials are disclosed in U.S. Pat. No. 6,303,238 to Thompson et al., which is incorporated by reference in its entirety. An example of an n-doped electron transport layer is BPhen doped with Li at a molar ratio of 1:1, as disclosed in U.S. Patent Application Publication No. 2003/0230980, which is incorporated by reference in its entirety. U.S. Pat. Nos. 5,703,436 and 5,707,745, which are incorporated by reference in their entireties, disclose examples of cathodes including compound cathodes having a thin layer of metal such as Mg:Ag with an overlying transparent, electrically-conductive, sputter-deposited ITO layer. The theory and use of blocking layers is described in more detail in U.S. Pat. No. 6,097,147 and U.S. Patent Application Publication No. 2003/0230980, which are incorporated by reference in their entireties. Examples of injection layers are provided in U.S. Patent Application Publication No. 2004/0174116, which is incorporated by reference in its entirety. A description of protective layers may be found in U.S. Patent Application Publication No. 2004/0174116, which is incorporated by reference in its entirety.

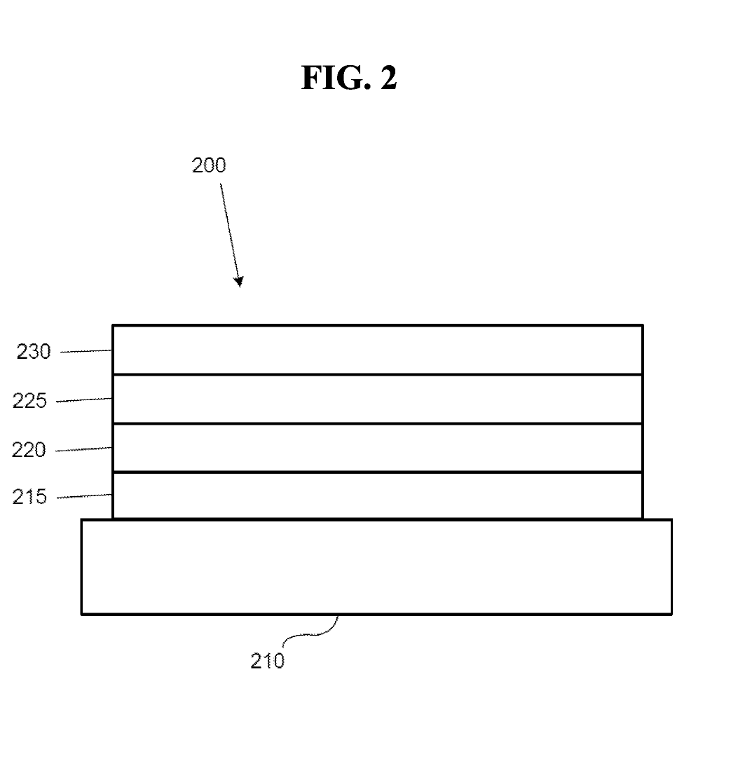

FIG. 2 shows an inverted OLED 200. The device includes a substrate 210, a cathode 215, an emissive layer 220, a hole transport layer 225, and an anode 230. Device 200 may be fabricated by depositing the layers described, in order. Because the most common OLED configuration has a cathode disposed over the anode, and device 200 has cathode 215 disposed under anode 230, device 200 may be referred to as an “inverted” OLED. Materials similar to those described with respect to device 100 may be used in the corresponding layers of device 200. FIG. 2 provides one example of how some layers may be omitted from the structure of device 100.

The simple layered structure illustrated in FIGS. 1 and 2 is provided by way of non-limiting example, and it is understood that embodiments of the invention may be used in connection with a wide variety of other structures. The specific materials and structures described are exemplary in nature, and other materials and structures may be used. Functional OLEDs may be achieved by combining the various layers described in different ways, or layers may be omitted entirely, based on design, performance, and cost factors. Other layers not specifically described may also be included. Materials other than those specifically described may be used. Although many of the examples provided herein describe various layers as comprising a single material, it is understood that combinations of materials, such as a mixture of host and dopant, or more generally a mixture, may be used. Also, the layers may have various sublayers. The names given to the various layers herein are not intended to be strictly limiting. For example, in device 200, hole transport layer 225 transports holes and injects holes into emissive layer 220, and may be described as a hole transport layer or a hole injection layer. In one embodiment, an OLED may be described as having an “organic layer” disposed between a cathode and an anode. This organic layer may comprise a single layer, or may further comprise multiple layers of different organic materials as described, for example, with respect to FIGS. 1 and 2.

Structures and materials not specifically described may also be used, such as OLEDs comprised of polymeric materials (PLEDs) such as disclosed in U.S. Pat. No. 5,247,190 to Friend et al., which is incorporated by reference in its entirety. By way of further example, OLEDs having a single organic layer may be used. OLEDs may be stacked, for example as described in U.S. Pat. No. 5,707,745 to Forrest et al, which is incorporated by reference in its entirety. The OLED structure may deviate from the simple layered structure illustrated in FIGS. 1 and 2. For example, the substrate may include an angled reflective surface to improve out-coupling, such as a mesa structure as described in U.S. Pat. No. 6,091,195 to Forrest et al., and/or a pit structure as described in U.S. Pat. No. 5,834,893 to Bulovic et al., which are incorporated by reference in their entireties.

Unless otherwise specified, any of the layers of the various embodiments may be deposited by any suitable method. For the organic layers, preferred methods include thermal evaporation, ink-jet, such as described in U.S. Pat. Nos. 6,013,982 and 6,087,196, which are incorporated by reference in their entireties, organic vapor phase deposition (OVPD), such as described in U.S. Pat. No. 6,337,102 to Forrest et al., which is incorporated by reference in its entirety, and deposition by organic vapor jet printing (OVJP), such as described in U.S. Pat. No. 7,431,968, which is incorporated by reference in its entirety. Other suitable deposition methods include spin coating and other solution based processes. Solution based processes are preferably carried out in nitrogen or an inert atmosphere. For the other layers, preferred methods include thermal evaporation. Preferred patterning methods include deposition through a mask, cold welding such as described in U.S. Pat. Nos. 6,294,398 and 6,468,819, which are incorporated by reference in their entireties, and patterning associated with some of the deposition methods such as ink jet and OVJD. Other methods may also be used. The materials to be deposited may be modified to make them compatible with a particular deposition method. For example, substituents such as alkyl and aryl groups, branched or unbranched, and preferably containing at least 3 carbons, may be used in small molecules to enhance their ability to undergo solution processing. Substituents having 20 carbons or more may be used, and 3-20 carbons is a preferred range. Materials with asymmetric structures may have better solution processibility than those having symmetric structures, because asymmetric materials may have a lower tendency to recrystallize. Dendrimer substituents may be used to enhance the ability of small molecules to undergo solution processing.

Devices fabricated in accordance with embodiments of the present invention may further optionally comprise a barrier layer. One purpose of the barrier layer is to protect the electrodes and organic layers from damaging exposure to harmful species in the environment including moisture, vapor and/or gases, etc. The barrier layer may be deposited over, under or next to a substrate, an electrode, or over any other parts of a device including an edge. The barrier layer may comprise a single layer, or multiple layers. The barrier layer may be formed by various known chemical vapor deposition techniques and may include compositions having a single phase as well as compositions having multiple phases. Any suitable material or combination of materials may be used for the barrier layer. The barrier layer may incorporate an inorganic or an organic compound or both. The preferred barrier layer comprises a mixture of a polymeric material and a non-polymeric material as described in U.S. Pat. No. 7,968,146, PCT Pat. Application Nos. PCT/US2007/023098 and PCT/US2009/042829, which are herein incorporated by reference in their entireties. To be considered a “mixture”, the aforesaid polymeric and non-polymeric materials comprising the barrier layer should be deposited under the same reaction conditions and/or at the same time. The weight ratio of polymeric to non-polymeric material may be in the range of 95:5 to 5:95. The polymeric material and the non-polymeric material may be created from the same precursor material. In one example, the mixture of a polymeric material and a non-polymeric material consists essentially of polymeric silicon and inorganic silicon.

Devices fabricated in accordance with embodiments of the invention can be incorporated into a wide variety of electronic component modules (or units) that can be incorporated into a variety of electronic products or intermediate components. Examples of such electronic products or intermediate components include display screens, lighting devices such as discrete light source devices or lighting panels, etc. that can be utilized by the end-user product manufacturers. Such electronic component modules can optionally include the driving electronics and/or power source(s). Devices fabricated in accordance with embodiments of the invention can be incorporated into a wide variety of consumer products that have one or more of the electronic component modules (or units) incorporated therein. Such consumer products would include any kind of products that include one or more light source(s) and/or one or more of some type of visual displays. Some examples of such consumer products include flat panel displays, computer monitors, medical monitors, televisions, billboards, lights for interior or exterior illumination and/or signaling, heads-up displays, fully or partially transparent displays, flexible displays, laser printers, telephones, cell phones, tablets, phablets, personal digital assistants (PDAs), laptop computers, digital cameras, camcorders, viewfinders, micro-displays, 3-D displays, vehicles, a large area wall, theater or stadium screen, or a sign. Various control mechanisms may be used to control devices fabricated in accordance with the present invention, including passive matrix and active matrix. Many of the devices are intended for use in a temperature range comfortable to humans, such as 18 degrees C. to 30 degrees C., and more preferably at room temperature (20-25 degrees C.), but could be used outside this temperature range, for example, from −40 degree C. to +80 degree C.

It has been found that OLED devices degrade during use. Such degradation typically is related to the current flow or luminance at which the device is operated. In general, one device color in a display or lighting panel will degrade faster than the others. Typically, blue devices degrade faster than red or green devices in an RGB side by side pixel arrangement. Typically in an RGBW arrangement that uses white devices with color filters, the white pixel degrades faster.

In some devices, if fixed images are shown on a display for a period of time, one of the sub-pixel colors may age faster than the others. For example, in a conventional RGB side by side pixel arrangement the blue sub-pixels within the image typically will degrade more than the red or green sub-pixels, resulting in an image “sticking,” i.e., being partially or entirely visible, in the display once the fixed image is removed and, for example, an all-white image is shown. For example, when showing a white image in the case of RGB side by side pixel arrangement in which the blue sub-pixels degrade faster than the red and green sub-pixels, the image sticking region will appear yellow compared to the regions around it, and a yellowish outline of the fixed image may be visible even after the image has been removed from the display. This phenomena is known as image sticking and generally is considered undesirable.

Previous methods to correct for image sticking generally rely on measuring the optical performance or, in some cases, the electrical performance of all the pixels in an OLED display. Such techniques are time consuming, complicated, and expensive, as additional circuits and electronics need to be incorporated into the display.

In contrast, embodiments disclosed herein may focus on the degradation of a pixel element within a particular display that is expected to degrade fastest, such as the blue sub-pixels in an RGB-type display, as it is these pixel elements that are most likely to be responsible for image sticking. In an embodiment, an expected degradation of blue sub-pixels in a display may be calculated, based on the characteristics of dummy blue pixels at the display edge, and/or integrated usage data for the blue sub-pixels in the display based on the video input. The display temperature, historical usage data, and other data also may be monitored and other correction factors may be applied to a received video signal. More generally, various compensation techniques may be applied to improve uniform color across all pixels in a display, regardless of the degradation expected for or exhibited by individual sub-pixels in the display.

In an embodiment, a display device may include a sensor or other mechanism to obtain historic operational data for and/or characteristics of one or more sub-pixels in the display. For example, data relating how a sub-pixel was previously driven may be obtained for a sub-pixel in a display device. As used herein, a “display device” may include the active area of a display, i.e., the region of the display that emits light and is capable of displaying an image, as well as other components such as a bezel or border, driving and control electronics, and associated hardware. Historic operational data may include, for example, the cumulative sum of luminance at which the sub-pixel is driven over time, or other luminance data for a sub-pixel. More generally, luminance data as disclosed herein measures or otherwise indicates the intensity at which a pixel element, such as a sub-pixel, is driven over a period of time. Luminance data may be obtained for a single sub-pixel, for a type or group of sub-pixels, for all sub-pixels of a particular type or color, or for all sub-pixels in the display. Luminance data may be obtained from sub-pixels within an active area of the display, or from sub-pixels positioned outside the active area of the display, which are not used in rendering video data by the active area of the display.

For example, a relatively small number of “dummy” or test pixels may be placed on the display periphery, i.e., outside the active area of the display. Such pixels may still be considered a part of the display device, or disposed in or within the display device, though they would not be used, for example, to display an image or general illumination by the display device as a whole since they are outside the active area of the display. When combined with an optical or similar sensor, the degradation versus time of a sub-pixel at a fixed luminance may be obtained. For example, a dummy sub-pixel may be driven at a constant current, and the luminance of the sub-pixel at that current may be measured. This data then may be used to predict how the dummy sub-pixel, or identical sub-pixels in an active area of the display, can be expected to degrade after being driven at known currents.

For example, the degradation versus time that corresponds to the blue sub-pixel luminance needed to produce a white image at maximum luminance may be obtained in a display where it is expected that the blue sub-pixels will experience the most rapid or most significant degradation. This will also result in the test sub-pixels being exposed to the same temperature profile as the rest of the display.

In some configurations, improved uniformity may be obtained by positioning additional test devices around the display periphery. An average degradation may be used, or a degradation profile from a test sub-pixel closest to a sub-pixel for which the degradation is to be characterized may be used. Such a configuration may include an integrated sensor that can record degradation in real time at maximum brightness. Sensors may be integrated into the backplane as thin film devices, e.g. TFTs, or may be positioned over or under the test OLEDs, depending on the display configuration. As disclosed elsewhere herein, temperature or other sensors also may be used so as to record luminance and temperature information at the test sub-pixels.

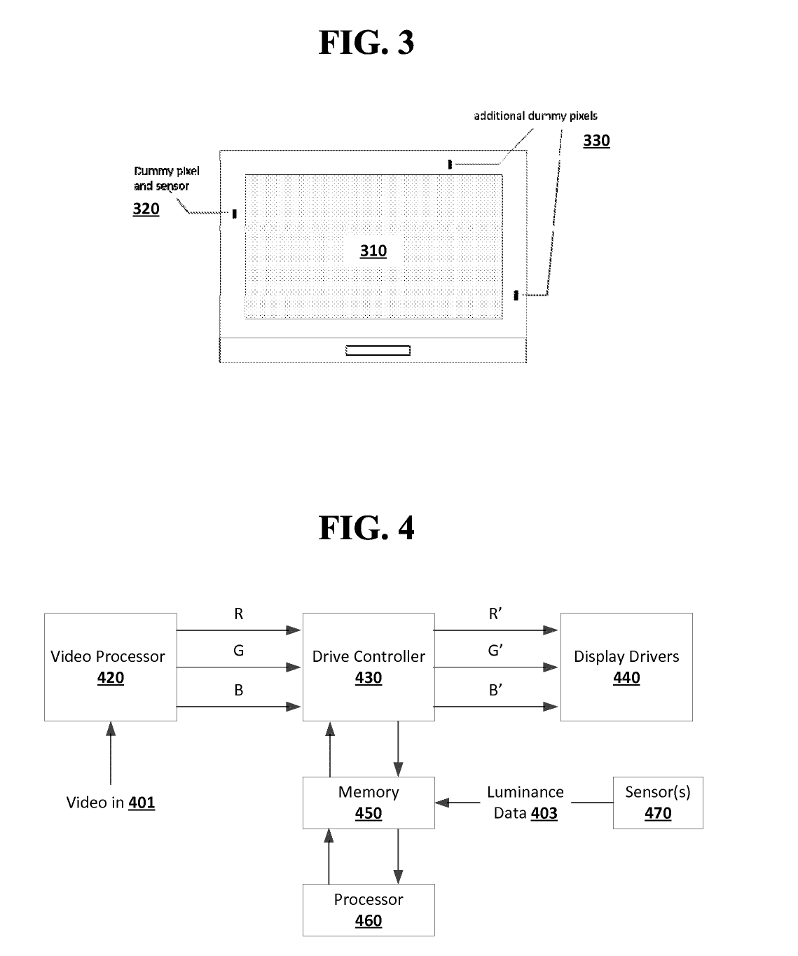

FIG. 3 shows an example device arrangement that includes dummy pixels arranged outside the active area of a display. As used herein, the “active area” of a display refers to the region of the display used to display video or other data on the display. Thus, dummy pixels may be disposed outside the video display area, such as within or under a border or bezel, within the device, or any other location. It may be preferred for the dummy pixels to be completely hidden from the view of a user of the device, so that in operation they do not interfere with the desired video data to be shown on the display. As shown in FIG. 3, a display may include an active area 310 and at least one dummy pixel 320. Additional dummy pixels 330 may be disposed in other areas outside the active area of the display, such as around the periphery of the device. The dummy pixels may include, or may be positioned such that they can be measured by one or more sensors as previously described.

Based upon the obtained historic operational data, an expected degradation level of one or more sub-pixels in the display may be calculated. For example, based upon the measured degradation at a maximum luminance of a sub-pixel, an expected degradation of all the sub-pixels in the display may be calculated.

For example, an expected degradation level may be calculated according to:

$${R}_{M} = {R}_{0} * {[ \frac{{L}_{M}}{{L}_{0}} ]}^{n} * [ \frac{{τ}_{M}}{{τ}_{0}} ] * exp [ \frac{Δ E}{k} * ( \frac{1}{{T}_{M}} - \frac{1}{{T}_{0}} ) ]$$

where R_{M} is the percentage drop in luminance over a time period τ_{M} at temperature T_{M}; R₀ is a known reference degradation at a reference luminance L₀ over a reference time τ₀; n is a luminance acceleration factor; L_{M} is the average luminance of the sub-pixel during the time period τ_{M}; ΔE is the activation energy of the temperature dependence; and T₀ is the reference temperature.

To predict pixel degradation, each dummy pixel of a given color placed around the display periphery may be driven with a constant current drive at some given luminance L₀, and then record the luminance over time, at time periods which are multiples of the sampling period. From the equation above, (R₀/τ₀) can be determined from recording R_{M} versus time for a dummy pixel, calculating the slope of R_{M} versus time and performing a least square fit to determine the slope. For the dummy pixels, L_{M}=L₀ and T_{M}=T₀, so the second and fourth terms of the right hand side containing these parameters will be unity. As a specific example, for green PHOLED devices, for L₀ of 20,000 nits and R₀ of 5%, then τ₀ is 200 hours at T=T_{M}=298K.

Once the slope for each color sub-pixel, or each sub-pixel of a color of interest, is known, the equation can be used to predict the R_{M} for each sub-pixel in the display. The incremental R_{M} for every sub-pixel for each sampling period can be calculated using the average luminance of that sub-pixel during the sampling period. L₀ is known from the dummy pixel luminance level.

The cumulative degradation for all sub-pixels within a display may be calculated over specific time intervals and recorded in memory. The video signal then may be adjusted to compensate for this degradation based on a correction scheme selected from those described in further detail below and the recorded sub-pixel degradation information. This adjustment may be performed in real-time. That is, the modification may be made as the initial video signal is received, so that the modified video is provided to, and may be displayed on, the display as it is modified. The modification may increase the luminance of a degraded sub-pixel such that if the degraded sub-pixel has a drop in luminance of x %, compared to its initial value, then the video signal will be increased by x % to compensate.

For example, historic operational data, including luminance data, may be obtained from dummy pixels, and the expected degradation calculated according to the equation above. The average usage of each sub-pixel over a specific time period may be calculated by summing each sub-pixel amplitude per frame and storing the cumulative sum in memory. Each sub-pixel degradation may be calculated according to the equation based on usage for a specific time interval, and this degradation may be added to previous cumulative degradation for each sub-pixel stored in memory. Real-time correction then may be applied to a received video input based on the cumulative degradation, so if degradation is x % for a given sub-pixel, the luminance will be increased by x %.

Once an expected degradation level is known for one or more pixels in the display, a video signal received by the display may be modified based upon the expected degradation level. For example, the luminance, power, color, or other attribute of the video signal, or a portion of the video signal, may be modified to obtain a consistent appearance across the different pixels in the display, which otherwise may have different display characteristics due to differences in degradation of the pixels.

In general, a video signal may be modified based upon an expected degradation level by adjusting the current provided to one or more sub-pixels in the display. For example, the current provided to sub-pixels of the same type as the sub-pixel or -pixels from which luminance data was collected may be modified. Alternatively, when luminance data is collected from a group of sub-pixels, all sub-pixels, or all sub-pixels of a type or color in the display, the current may be adjusted to a selected group of sub-pixels based upon the expected degradation levels calculated for those specific sub-pixels. As another example, as described in further detail below, a current provided to one or more sub-pixels in the display may be modified based upon an expected luminance of a most-degraded pixel in the display.

In some configurations, a user may enable or disable such adjustment by the display. For example, a display may include a user interface that provides settings for the user to control whether and how the display performs image sticking correction.

A variety of techniques may be used to modify operation of the display and remove image sticking. In one scheme, the drive current of degraded pixels may be boosted so that their luminance returns to a level near or at 100%. Given that the display knows the luminance of every sub-pixel of interest, for example, the luminance of each pixel that is most likely to degrade first, the overdrive or correction needed to boost each sub-pixel luminance back to its un-degraded level may be readily determined. The display may then adjust a video input signal to achieve this correction.

In another scheme to modify operation of a display, the luminances of sub-pixels over the whole display may be reduced to the level of the most degraded sub-pixels, so as to make uniform degradation over the whole display. For example, if a degradation level is calculated for or based upon blue sub-pixels, the luminance of all blue sub-pixels in the display may be reduced to the level of the most-degraded blue sub-pixel. In this case image sticking will be removed, but the display may “yellow” over time. If every blue sub-pixel has the same reduced performance, the overall display white point will change to a warmer color temperature, but any image sticking will be removed as spatial images will be removed.

This modification may be accomplished, for example, by noting the degradation of the most degraded sub-pixels of a particular type, such as blue sub-pixels, and reducing the drive signal to the remaining sub-pixels of that type so all output is uniform across the display. That is, a correction factor may be placed on the drive signals to the sub-pixels of that type, which will produce a uniform image across the display. Such correction factors may be stored in memory and used to adjust the signals during normal operation so as to remove image sticking, or sub-pixel non-uniformities. As previously described, a display may make such an adjustment to a video input signal in real-time to achieve this correction.

In another scheme, system electronics may be used to scale down the driving current so as to reduce luminances of all sub-pixels over the whole display to the level of the most degraded sub-pixels, so as to make the degradation uniform in luminance and color over whole display. For example, the luminances of red, green, and blue sub-pixels may be reduced to the level of the most-degraded blue sub-pixels. In this case image sticking may be reduced or removed, but the overall display may be expected to dim over time. Thus, it also may be desirable for such a technique to account for the color balance between the sub-pixels to produce white light. One approach may be to note the percentage decrease in the light output of the most degraded sub-pixel, and apply this to all the remaining sub-pixels so as to produce uniform output (as described above), and then reduce the other sub-pixels by the same percentage. For example, the percentage decrease of the most-degraded blue sub-pixel may be applied to all remaining blue sub-pixels, and the red and green sub-pixels may be reduced by the same percentage.

In some cases, it may be desirable to make sure that outlier degraded pixels do not distort the calculation of the expected degradation level. For example, luminance data for degraded sub-pixel clusters may be used, rather than for just single pixels. Such a calculation may, for example, represent areas of heavy use of a particular color, such as where static icons are repeatedly displayed in the same region of a screen. As a specific example, the active area of the display may be divided into regions of a set number of pixels, such as 8, 16, or 24 pixels, and an average degradation over each region used for the luminance adjustments of the display.

In an embodiment, it may be desired to also characterize and predict the degradation of the sub-pixels of types not expected to be the most-degraded. For example, in a conventional RGB display, it may be helpful to calculate expected degradation values for green and red sub-pixels as well as blue. This may be accomplished, for example, by also depositing red and green dummy pixels and corresponding sensors outside the active area of the display. The same techniques used to predict blue sub-pixel degradation also may be used to predict green and red sub-pixel degradation.

The modification and correction schemes disclosed herein may be applied to a variety of display architectures, such as four-pixel RGB1B2 displays, displays having yellow and blue sub-pixels with color filters, RGBW, and sub-pixel rendering layouts. For example, in a RGBW architecture, the white sub-pixel may be corrected to achieve a desired output.

In an embodiment, historic operational data, such as luminance data for one or more sub-pixels as disclosed herein, may be stored in a computer-readable memory, which may be a part of or communicatively coupled to the display device. The data may be updated occasionally during operation of the display. For example, it may be updated periodically, i.e., at regular set intervals. As another example, the luminance data may be updated at set or irregular times during operation of the display, such as when appropriate processing resources are available to measure and record the luminance data. As a specific example, a video signal may be monitored, and the cumulative intensity level of every sub-pixel over time may be stored. Example sampling times may be once a second, once every 10 seconds, or the like. A known degradation versus time curve at varying intensities may then be used by to calculate or estimate display degradation for all the display pixels based on their luminance and temperature during the sampling period. Thus, for example, parameters from the degradation of edge pixels may be used to determine display degradation across the entire active area, pixel by pixel. Notably, the luminance data used to calculate expected degradation levels and/or the expected degradation level data as disclosed herein may be stored in a memory of a display and updated over time as the display is operated. Modifications made to operation of the display thereby may be selected based upon the most current information about display operation available.

FIG. 4 shows a schematic representation of an example system for performing the luminance and degradation calculations and video modification described herein. A video processor 420 in a display may receive an incoming video signal 401 as an input. The video processor may provide various signals to a drive controller 430 indicating how the video signal may be displayed in the specific architecture of the display. In the example shown in FIG. 4, the video processor 420 provides red, green, and blue (R, G, B, respectively) display data, such as to allow the video signal 401 to be displayed on a RGB display. Other display architectures as disclosed herein also may be used, in which case the video processor 420 may provide the appropriate individual color signals to allow display of the video signal 401 on the display. For example, the display may use more than three primary colors to display the video signal 401 on the display. The signals provided by the video processor may be provided to a drive controller 430, which then may generate modified color signals (R′, G′, B′) that are provided to individual display drivers 440, such as column drivers in an RGB display, which control the individual sub-pixels in the display. The drive controller 430 may make any of the modifications disclosed herein to the various color signals, so as to implement the disclosed image sticking reduction techniques.

As previously disclosed, the modifications performed by the drive controller 430 may be based upon historic operational data 403 that is obtained from one or more sensors 470 in the display, and which may be stored in a computer-readable memory 450. Similarly, the memory 450 may store and provide expected degradation values which may be, for example, calculated by a processor 460 in the display. The luminance data and/or degradation levels may be used to generate the specific modifications performed on the video signal 401 by the drive controller 430 and/or the processor 460, as previously disclosed herein.

As previously described, the sensors 470 may include luminance sensors, temperature sensors, or any other sensor used to capture and provide information about sub-pixels, such as dummy sub-pixels, in the display. Luminance sensors may be used to capture the luminance of sub-pixels over time, so that the historical luminance of each sub-pixel may be stored in the memory 450. The associated current at which the sub-pixel was driven for a particular luminance value also may be stored in the memory 450 to allow for correlation of luminance and driving current as previously described. Other data may be captured and stores as well. For example, different display areas may operate at different temperatures, due to, for example, the proximity to heat generating processors or other components, the total brightness of that region of the display, and the like. Since sub-pixels can degrade at different rates based on the temperature, temperature sensors may be positioned within the display and local temperature information can be recorded for each pixel in the area.

In some configurations, such as in display architectures in which it may be difficult to introduce dummy test pixels and/or detectors into the display edge, device reference degradation characteristics such as R₀, L₀, τ₀, τ₁, n, and/or ΔE as previously described may be predetermined based on preliminary testing of the same device pixels outside the display. For example, the specific OLED devices to be incorporated into the display and/or identical devices may be driven as known currents and reference luminance data may be obtained before the devices are incorporated into a display or other device. Predetermined calibration characteristics also may be used in combination with the characteristics determined from dummy pixels on the display.

FIG. 4 shows several components individually for purposes of illustration. However, various functionality may be combined into a single component, module, chip, integrated circuit, or the like. For example, the video processor 420 and drive controller 430 functionality as disclosed herein may be performed by a single component, such as a combined chip. Similarly, the various functions described with respect to one component may be performed by another component as disclosed, or by other components not shown in FIG. 4, without departing from the scope of the present disclosure. The data shown also may be directly obtained and/or used by components other than as shown in FIG. 4. For example, a processor 460 may directly obtain luminance data 403 from one or more sensors in the display, or the processor 460 may perform various pre-processing on the luminance data before it is stored in the memory 450. Other variations on the specific data manipulation and storage functions disclosed herein may be used without departing from the scope of the present disclosure.

Although described with respect to a general display device, a device such as shown in FIG. 4 and described throughout the present disclosure may be, or include, any suitable device, including a flat panel display, a computer monitor, a medical monitor, a television, a billboard, a heads-up display, a wearable display, wearable computer, electronic watch, a computer, a fully or partially transparent display, a flexible display, a laser printer, a telephone, a cell phone, a tablet, a phablet, a personal digital assistant (PDA), a laptop computer, a digital camera, a camcorder, a viewfinder, a micro-display, a 3-D display, a vehicle, a large area screen, a sign, or any other similar device.

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore include variations from the particular examples and preferred embodiments described herein, as will be apparent to one of skill in the art. It is understood that various theories as to why the invention works are not intended to be limiting.

1. A method comprising:
obtaining historic operational data for at least a portion of a display device comprising a display;
calculating an expected degradation level of a sub-pixel within an active area of the display based upon the historic operational data; and
modifying a video signal received by the display device based upon the expected degradation level to generate a modified video signal; and
providing the modified video signal to the display.

2. The method of claim 1, wherein the historic operational data comprises a cumulative brightness at which the display is driven over the period of time.

3. The method of claim 1, wherein the modification is made in real time.

4-6. (canceled)

7. The method of claim 1, wherein the historic operational data is stored in a computer-readable memory of the display device.

8. The method of claim 7, wherein the historic operational data is updated occasionally or periodically during operation of the display.

9. (canceled)

10. The method of claim 1, further comprising:
receiving temperature data from a temperature sensor in the display device;
wherein the expected degradation level is further calculated based upon the temperature data.

11. The method of claim 1, wherein the step of modifying the video signal comprises:
adjusting a current provided to a sub-pixel in the display having the same color as the sub-pixel based upon the expected degradation level.

12-14. (canceled)

15. The method of claim 1, wherein the step of obtaining the historic operational data further comprises:
obtaining an intensity level for each of a plurality of sub-pixels in the display over a period of time.

16. The method of claim 1, wherein the step of modifying the video signal comprises:
reducing a current provided to a plurality of sub-pixels in the display based upon an expected luminance of a most-degraded pixel in the display.

17. The method of claim 1, wherein the sub-pixel is a blue-emitting sub-pixel.

18. The method of claim 1, wherein the historic operational data comprises luminance data for the sub-pixel within the active area of the display, the luminance data indicating an intensity at which the sub-pixel is driven over a period of time.

19. The method of claim 1, wherein the historic operational data comprises luminance data for the sub-pixel within the active area of the display, the luminance data indicating an intensity at which the sub-pixel is driven over a period of time, wherein the expected degradation is calculated based on a characteristic of a dummy sub-pixel disposed outside an active area of the display.

20. (canceled)

21. The method of claim 1, wherein the historic operational data comprises representative luminance data for a dummy sub-pixel disposed outside an active area of the display.

22-23. (canceled)

24. The method of claim 1, wherein the historic operational data comprises a degradation level of a dummy sub-pixel disposed outside an active area of the display.

25. (canceled)

26. A device comprising:
a full-color display;
a computer-readable storage storing historic operational data for at least a portion of the display; and
a processor configured to calculate an expected degradation level of a sub-pixel within an active area of the display based upon the historic operational data and to modify a video signal received by the display device based upon the expected degradation level.

27. The device of claim 26, wherein the device comprises at least one device selected from the group consisting of: a flat panel display, a computer monitor, a medical monitor, a television, a billboard, a heads-up display, wearable display, wearable computer, electronic watch, a computer, a fully or partially transparent display, a flexible display, a laser printer, a telephone, a cell phone, a tablet, a phablet, a personal digital assistant (PDA), a laptop computer, a digital camera, a camcorder, a viewfinder, a micro-display, a 3-D display, a vehicle, a large area screen, and a sign.

28. The device of claim 26, further comprising a sensor configured to obtain a characteristic of a dummy sub-pixel disposed outside an active area of the display.

29. The device of claim 28, wherein the processor is configured to calculate the expected degradation based on the characteristic of the dummy sub-pixel.

30-31. (canceled)

32. The device of claim 26, further comprising a temperature sensor;
wherein the processor is further configured to calculate the expected degradation level based upon temperature data received from the temperature sensor.

33-34. (canceled)

35. The device of claim 26, wherein the sub-pixel is a blue-emitting sub-pixel.
